(19) United States
(12) Patent Application Publication
(10) Pub. No.: US 2004/0180719 A1
(43) Pub. Date: Sep. 16, 2004

(54) Game controller support structure and isometric exercise system and method of facilitating user exercise during game interaction

(76) Inventors: Philip Feldman, Catonsville, MD (US); Greg Merril, Bethesda, MD (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/806,280

(22) Filed: Mar. 23, 2004

Related U.S. Application Data
(63) Continuation-in-part of application No. 10/309,565, filed on Dec. 4, 2002.
(60) Provisional application No. 60/514,897, filed on Oct. 29, 2003.

(51) Int. Cl. A63F 13/00

(52) U.S. Cl. 463/36

(57) ABSTRACT

A game controller support structure according to the present invention is configured to require a user to operate a game controller in a standing position during game play. The support structure includes a frame with a base, a body support, a game controller and a stand. The stand is attached to the base and supports the game controller, while a user lower body is engaged by the body support. The stand and body support may be adjustable to accommodate various users. In addition, the support structure may be in the form of an isometric exercise system that enables a user to perform isometric exercises during game play to interact with the game.

### CROSS-REFERENCE TO RELATED APPLICATIONS

This application is a Continuation-in-Part of copending U.S. patent application Ser. No. 10/309,565, entitled “Computer Interactive Isometric Exercise System and Method for Operatively Interconnecting the Exercise System to a Computer System for Use as a Peripheral” and filed Dec. 4, 2002. In addition, this application claims priority from U.S. Provisional Patent Application Serial No. 60/514,897, entitled “Configurable Game Controller and Method of Selectively Assigning Game Functions to Controller Input Devices” and filed Oct. 29, 2003. The disclosures of the aforementioned patent applications are incorporated herein by reference in their entireties.

### BACKGROUND OF THE INVENTION

1. Technical Field

The present invention pertains to support structures for video or other game controllers. In particular, the present invention pertains to a support structure for a game controller that requires a user to stand in order to operate the controller and participate in a video or other game. Further, the game controller structure may be in the form of an isometric exercise system that enables the user to perform isometric exercises to interact with the game.

2. Discussion of the Related Art

Generally, the operation of video and computer games is performed by users in a sitting or reclining position (e.g., on a couch, chair, floor, etc.). Accordingly, the use of video games tends to decrease the amount of exercise being performed by users. This lack of sufficient exercise may contribute to a growing population of overweight people or even an epidemic of obesity.

In order to enhance the exercise performed by users during a game, the present invention positions the game controller at a sufficient height to require game play by a user be performed in a standing position. In other words, the present invention prevents game play by users in a sitting or reclining position. The standing position enables the user to consume considerably more calories during game play since the large muscles of the user legs are being utilized. In addition, the present invention may be in the form of an isometric exercise system enabling a user to perform isometric exercises to interact with the game, thereby facilitating exercise and consumption of an increased quantity of calories during game play.

### OBJECTS AND SUMMARY OF THE INVENTION

Accordingly, it is an object of the present invention to require a user to stand and/or exercise during usage of video or other games to enhance user exercise during game play.

It is another object of the present invention to support a game controller in a position requiring a user to operate the game controller in a standing position and/or to exercise to interact with the game to enhance consumption of calories during game play.

Yet another object of the present invention is to employ an isometric exercise system in the form of a game controller to require a user to perform isometric exercises to interact with the game.

The aforesaid objects are achieved individually and/or in combination, and it is not intended that the present invention be construed as requiring two or more of the objects to be combined unless expressly required by the claims attached hereto.

According to the present invention, a game controller support structure is configured to require a user to operate a game controller in a standing position during game play. The support structure includes a frame with a base, a body support, a game controller and a stand. The stand is attached to the base and supports the game controller, while the base is sufficiently wide to maintain the stand and controller in a generally upright position. The stand includes a height sufficient to enable a user (e.g., generally having a height of five to six feet) to comfortably use the controller in a standing position, where a user lower body is engaged by the body support. However, the stand and body support may be adjustable to accommodate a greater range of user heights. The stand may further be incorporated into other devices or frames that accommodate the user during game play (e.g., keyboard holders, body braces, cup holders, etc.). The game controller may be in the form of a custom controller and be integrated into the top of the stand or, alternatively, the game controller may be a conventional or “off the shelf” controller and be clamped or otherwise secured to the stand. In addition, the support structure may be in the form of an isometric exercise system that enables a user to perform isometric exercises during game play to interact with the game.

The above and still further objects, features and advantages of the present invention will become apparent upon consideration of the following detailed description of specific embodiments thereof, particularly when taken in conjunction with the accompanying drawings, wherein like reference numerals in the various figures are utilized to designate like components.

### BRIEF DESCRIPTION OF THE DRAWINGS

FIG. 1 is a diagrammatic illustration of an exemplary gaming system employing the game controller support structure and exercise system of the present invention.

FIG. 2 is a view in perspective of a game controller support structure according to the present invention.

FIG. 3 is a block diagram of a game controller for use with the game controller support structure of FIG. 2.

FIG. 4A is a view in perspective of an alternative configuration for the structure of FIG. 2 to adjust the stand and/or body support height according to the present invention.

FIG. 4B is a view in perspective of another configuration for the structure of FIG. 2 including a pivot mechanism to adjust the controller and/or support member position to accommodate a user according to the present invention,

FIG. 4C is view in perspective of the stand of the structure of FIG. 2 utilized to support the game controller from a supporting surface according to the present invention.

FIG. 5 is a view in perspective of a game controller support structure in the form of an isometric exercise device according to the present invention.

FIG. 6 is a schematic block diagram of an exemplary control circuit for the isometric exercise device of FIG. 5.

### DETAILED DESCRIPTION OF THE PREFERRED EMBODIMENTS

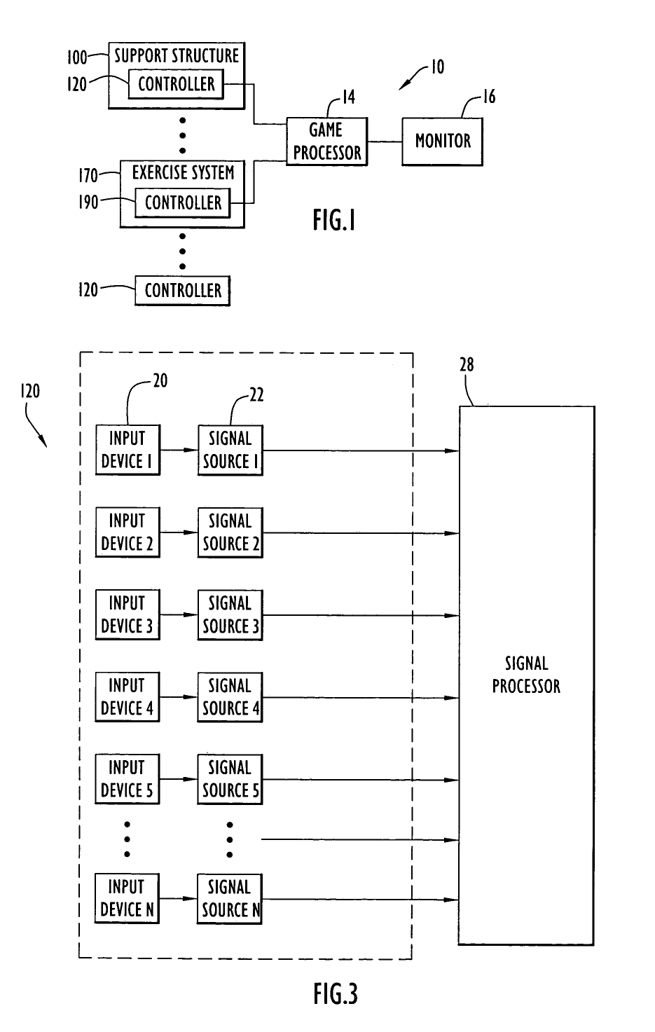

A gaming or entertainment system employing a game controller support structure according to the present invention is illustrated in FIG. 1. Specifically, gaming system 10 includes one or more controllers 120, 190, a game processor 14 and a monitor or display 16. A controller 120 may be mounted within a corresponding support structure 100, while a controller 190 may be mounted within a corresponding support structure in the form of an isometric exercise system 170 as described below. The game processor includes a storage drive and/or unit to receive computer readable media (e.g., CD, DVD, etc.) containing software for various games and a processing device to execute the software to provide games on monitor 16. The game processor may be implemented by any conventional or other processor (e.g., microprocessor, personal computer, video gaming processor, etc.). For example, the game processor may be implemented by conventional video games, such as PS2 available from Sony, XBOX available from Microsoft or GAMECUBE available from Nintendo. The monitor is typically implemented by a conventional television or other display. The games generally include characters or objects that are controlled by a user via controllers 120, 190 and/or performance of exercises. By way of example only, the user may control movement and actions of a character or a vehicle (e.g., car, airplane, boat, etc.) to move through a virtual environment displayed on monitor 16. The controllers include a plurality of input devices (e.g., joystick, buttons, etc.) to enable a user to interact with the game. The game processor receives signals from the controllers and updates the display to reflect the movements and/or actions of the character or object as indicated by user manipulation of the controller and/or user exercise.

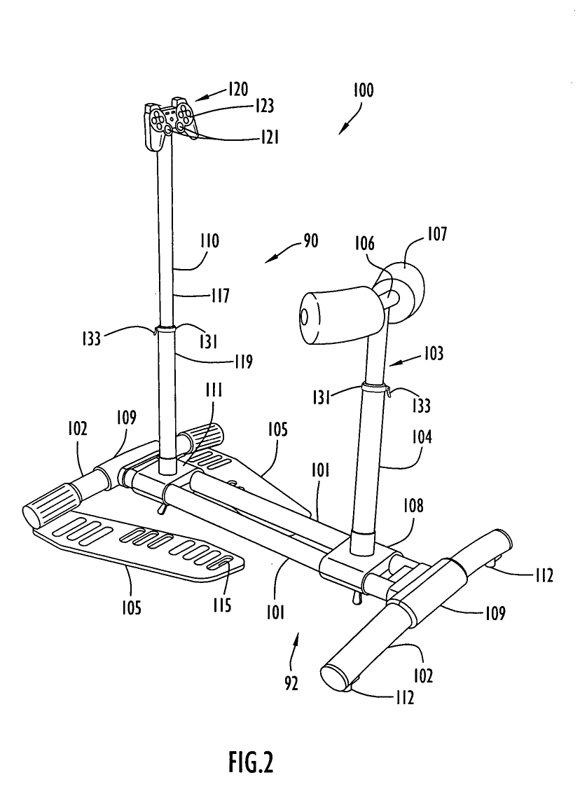

The operation of video and computer games is generally performed by users in a sitting or reclining position (e.g., on a couch, chair, floor, etc.), thereby decreasing or minimizing the amount of exercise being performed by users. In order to enhance the exercise performed by users during a game, the present invention support structure positions the game controller at a sufficient height to require that game play by a user be performed in a standing position. A game controller support structure according to the present invention that requires operation of the controller by a user in a standing position is illustrated in FIG. 2. Specifically, structure 100 includes a frame 90 with a base 92 including a pair of elongated base mounting members 101 and a pair of elongated base stability members 102. The base mounting and stability members are each preferably implemented by substantially cylindrical posts or rods. The base mounting members are spaced apart by a slight distance and basically extend along the structure longitudinal axis substantially in parallel. The base stability members are each attached at a corresponding end of the base mounting members via brackets or clamps 109 and extend transversely therefrom to form an “I” configuration for the base.

The base stability members engage a support surface (e.g., floor, etc.) to stabilize the structure frame and include a slight curved configuration to suspend the base mounting members slightly above that surface. The base stability member at the front of the structure may include grips 105 disposed at each end and extending rearward therefrom to provide a gripping surface for user feet. The grips are each generally rectangular and include a series of slots 115 defined therein to enhance gripping between the gripping surface and user feet. The front and/or rear stability members may include feet 112 each disposed toward a corresponding stability member end to engage the support surface. The structure feet enhance gripping and/or maintain the support structure in a substantially level orientation. Feet 112 may be of any quantity, shape or size, may be disposed at any suitable locations and may be constructed of any suitable gripping materials (e.g., rubber, plastic, etc.). Alternatively, the structure may include a gripping platform (not shown) constructed of a suitable gripping material (e.g., rubber, plastic, etc.) for engagement by user feet. The gripping platform may include a single sufficiently sized platform or a plurality of segments or planks of any shape or size and arranged in any fashion to accommodate the structure and user feet. In this case, feet 112 may facilitate mounting of the structure to the gripping platform and maintain the structure in a substantially level orientation.

Body support 103 is configured to support a user lower body portion (e.g., buttocks, etc.) and is secured to a rear portion of the base mounting members via a bracket or clamp 108. Body support 103 includes a substantially upright post 104 and a support member 106. The post and support member are preferably in the form of substantially cylindrical rods with the support member being attached to the top of the upright post and extending transversely therefrom to form a “T” type configuration. The support member includes a curved configuration to contour a user body portion and generally cylindrical pads 107 extending inward from each support member end to enhance user comfort. The user lower portion (e.g., buttocks, etc.) is basically placed within the support member interior and against pads 107 during game play to support the user in a standing position.

Frame 90 further includes a stand or post 110 for supporting controller 120. In particular, stand 110 is attached, via a bracket or clamp 111, to base mounting members 101 proximate front base stability member 102. The stand is substantially upright and preferably modular and is constructed of a suitably rigid material (e.g., plastic, a metal, etc.). While the stand is generally cylindrical, it is noted that the stand may be of any suitable shape (e.g., bent or curved, V-shaped, etc.) and have any suitable exterior surface geometries (e.g., curved, multifaceted, etc.).

Controller 120 is attached or secured to the stand upper portion. The controller is coupled to game processor 14 (FIG. 1) via cables (not shown) that may extend from the controller externally of or internally through stand 110. The controller may be of the type available for conventional video games (e.g., PS2 available from Sony, XBOX available from Microsoft, GAMECUBE available from Nintendo, etc.), such as the device described in U.S. Pat. No. 6,231,444, the disclosure of which is incorporated herein by reference in its entirety. In this case, the controller may be secured to the stand upper portion via conventional or other fastening devices (e.g., clamps, brackets, etc.). Alternatively, the controller may be custom manufactured and formed integral with stand 110.

Controller 120 preferably includes a series of buttons 123 and one or more joysticks 121 to interact with the game. Further, the controller generally includes respective signal sources (e.g., variable resistors or potentiometers, switches, etc.) to provide signals indicating button actuation and joystick motion along X (e.g., left/right motions) and Y (e.g., forward/back motions) axes as described below. However, the controller may include any quantity of any type of input devices (e.g., buttons, switches, a keypad, joystick, etc.) and signal sources disposed at any location and arranged in any fashion on the controller, where the buttons and joystick may be utilized to enter any desired information (e.g., enter desired user actions for the game, etc.).

Referring to FIG. 3, controller 120 generally includes input devices 20 and signal sources 22 each associated with an input device. Input devices 20 are each manipulable by a user to enter information or perform some action within a game. These devices include buttons 123 and joysticks 121 (FIG. 2), and may be in the form of any conventional or other controller input devices (e.g., buttons, switches, joysticks, etc.). The input devices are each coupled to one or more corresponding signal sources 22. The signal sources each basically detect or measure manipulation of a corresponding input device and produce a signal indicating the measurement or detection. The signal sources may be implemented by any conventional or other components (e.g., switch, contact, variable resistor or potentiometer, etc.). By way of example only, a controller input device in the form of a button may be associated with a signal source in the form of a contact or switch that closes a circuit in response to button actuation, thereby producing a signal indicating that condition. Further, a controller input device in the form of a joystick may have each particular axis of motion be associated with a respective signal source in the form of a variable resistor or potentiometer whose resistance varies in accordance with joystick motion along that axis. The signal source produces a signal indicating a measurement of joystick motion along the corresponding axis.

The signals produced by signal sources 22 are processed by a signal processor 28. The signal processor may be in the form of game processor 14 (FIG. 1) or a conventional or other processor that may be disposed within controller 120. The signal processor arranges the signal information into a format compatible with game processor 14. The inputs of signal processor 28 are coupled in a fixed manner to specific controller signal sources. Thus, the signal processor or game processor knows the controller input device associated with each input and maps game functions to those inputs (or controller input devices) in accordance with the assignments within the game software.

Referring back to FIG. 2, stand 110 and body support 103 of structure 100 may be of fixed dimensions or may be adjustable to accommodate various user heights and body portions. Specifically, stand 110 and body support 103 may each include a substantially cylindrical upper rod 117 and a substantially cylindrical lower rod 119. The dimensions of lower rod 119 are greater than those of upper rod 117 to permit the upper rod to be partially inserted into the lower rod in a sliding or telescoping arrangement. A clamp 131 is disposed about the lower rod upper portion. The clamp includes a tension member 133 that serves to increase or decrease the pressure applied by the clamp to the lower rod. The tension member is preferably in the form of a lever, but may be any conventional or other securing or tension devices (e.g., screw, nut, bolt, lever, etc.). Once the upper rod is adjusted relative to the lower rod to place the corresponding controller or support member at a desired position, the tension member is manipulated to tighten the clamp. The clamp basically applies pressure to the lower rod walls to frictionally engage the walls of upper rod 117 inserted within the lower rod. The frictional engagement prevents the upper rod from sliding relative to the lower rod, thereby effectively locking the upper rod (and corresponding game controller or support member) at a desired height or position. The tension member may be manipulated to loosen the clamp, thereby enabling the upper rod position to be altered as described above. The clamp and tension member may be implemented by any conventional or other clamp or pressure application devices.

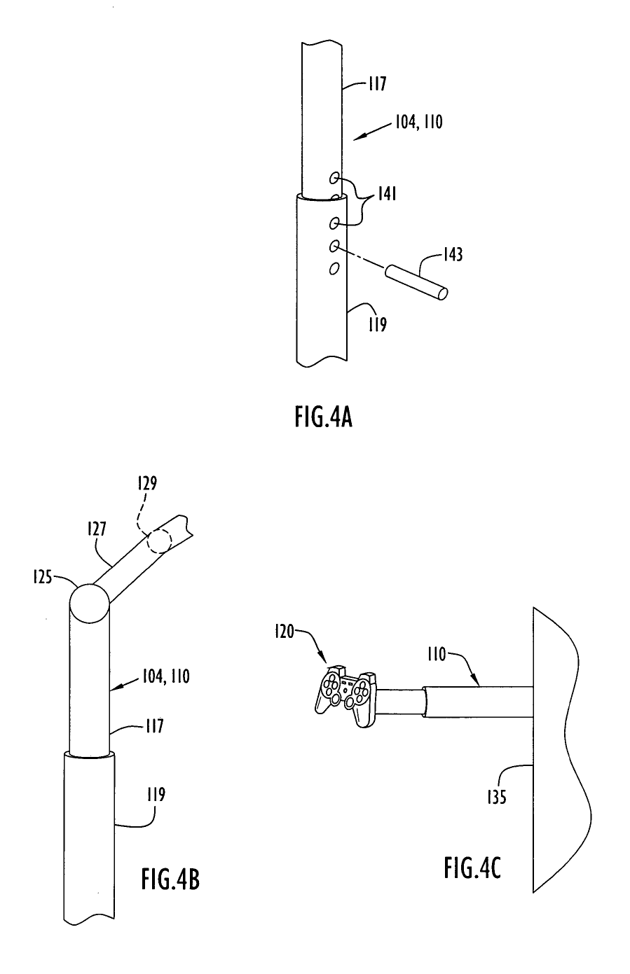

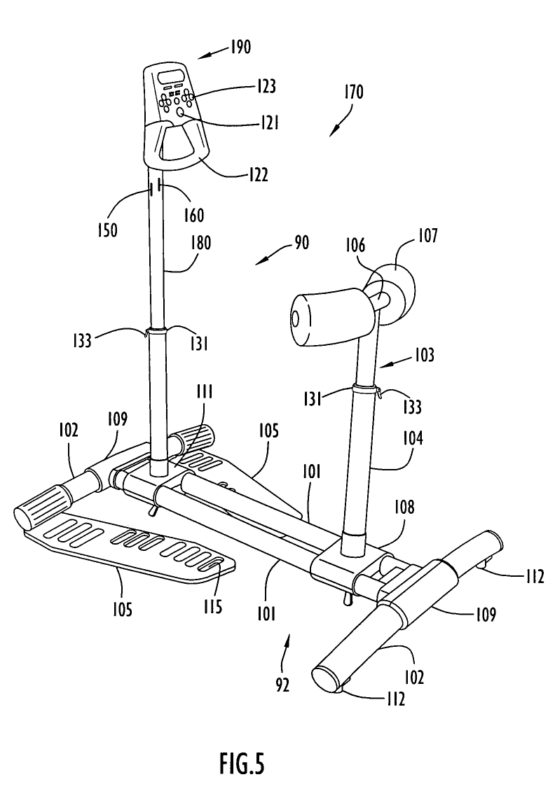

An alternative embodiment of an adjustable stand 110 and body support 103 is illustrated in FIG. 4A. Specifically, stand 110 and body support 103 may each include substantially cylindrical upper rod 117 and substantially cylindrical lower rod 119 as described above. The dimensions of lower rod 119 are greater than those of upper rod 117 to permit the upper rod to be partially inserted into the lower rod in a sliding or telescoping arrangement as described above. The upper and lower rods each include a series of openings 141. The openings are disposed toward a lower portion of the upper rod and toward an upper portion of the lower rod, thereby enabling alignment or overlap of the openings during adjustment of the corresponding controller or support member height. The openings include dimensions slightly greater than those of a pin 143 to receive the pin and adjust the height of the corresponding stand or body support. In particular, the upper rod is inserted into the lower rod until the corresponding controller or support member is at a desired height and at least one opening of each rod is aligned. Pin 143 is substantially cylindrical and is inserted into the appropriate aligned openings to secure the rods in the desired configuration and place the corresponding controller or support member at the desired height. The pin may be removed from the openings to enable the corresponding controller or support member position to be altered as described above. The openings may be of any quantity, shape or size and may be arranged in any fashion on the rods to adjust the height of the corresponding stand or body support.

The stand and body support may further include pivoting mechanisms to enable adjustment of controller or support member position as illustrated, by way of example only, in FIG. 4B. Specifically, stand 110 and body support 103 may each include substantially cylindrical upper rod 117 and substantially cylindrical lower rod 119, each substantially similar to those described above. The lower and upper rods may be fixed relative to each other, or may be configured in the manners described above to facilitate adjustment of height. Controller 120 and support member 106 may each be secured to a corresponding arm 127. The arm is preferably substantially cylindrical, but may be of any shape, and is coupled to a corresponding upper rod 117 via a pivot mechanism 125 disposed at the upper portion of the upper rod. The pivot mechanism may be implemented by any conventional or other mechanisms (e.g., bearings, hinges, ratchets, gears, gimbal, etc.) enabling arm 127 to be manipulated relative to upper rod 117. For example, the pivot mechanism may enable arm 127 to be moved longitudinally and/or transversely (e.g., moved in any desired angular motion) relative to the upper rod. The stand and/or body support may be manipulated to respectively place the controller and/or support member at a desired height and at a desired position or orientation relative to a user for game play. Further, the pivot mechanism may include any conventional or other stop or lock mechanism to maintain the corresponding controller or support member at the desired position and/or orientation.

In addition, the stand and body support may each include an additional pivot mechanism 129. This mechanism is substantially similar to pivot mechanism 127 described above and is disposed toward a corresponding arm distal end to enable the corresponding controller or support member to be manipulated relative to the arm. For example, mechanism 129 may enable the corresponding controller or support member to be moved longitudinally or transversely (e.g., moved in any desired angular motion) relative to the arm. The controller or support member may be manipulated to any desired position or orientation relative to a user for game play. Further, the pivot mechanism may include any conventional or other stop or lock mechanism to maintain the corresponding controller or support member in the desired position and/or orientation.

The stands described above may be used with various devices or frames (e.g., keyboard holders, body braces, cup holders, etc.) to support the game controller. Further, the stands may be attached to any supporting surfaces as illustrated in FIG. 4C. Specifically, stand 110 may be attached or secured to a supporting surface 135 (e.g., in the form of a wall, ceiling, door, furniture, etc.). The stand is secured in a manner to place the controller at a height requiring a user to operate the controller in a standing position as described above. The stand may include any of the adjustment configurations described above and may be manipulated to place the controller at any desired height, position and/or orientation relative to a user for game play.

Operation of the game controller support structure is described with reference to FIGS. 1-3. Initially, a user couples the controller to game processor 14. A game is selected and executed on the game processor, and the user mounts structure 100 by placing user feet on grips 105 (or the gripping platform) and a user lower body portion (e.g., buttocks, etc.) against support member 106 as described above. The structure places the controller at a desired height to require the user to stand during game play. The structure may further include an adjustable configuration, where the controller and/or support member may be manipulated to desired positions as described above. Once the user is situated on the structure, the controller is manipulated by the user in a standing position to interact with the game.

The game controller support structure may be in the form of an isometric exercise device or system enabling a user to perform isometric exercises to interact with the game, thereby facilitating exercise and consumption of an increased quantity of calories during game play. A game controller support structure in the form of an isometric exercise device or system is illustrated in FIG. 5. Initially, isometric exercise device or system 170 is substantially similar to game controller support structure 100 described above for FIG. 2 and is of the type disclosed in aforementioned U.S. patent application Ser. No. 10/309,565. The exercise system basically enables the user to interact with the game in accordance with exercise performed by the user on the system as described below.

Specifically, isometric exercise device or system 170 includes frame 90 with base 92 including elongated base mounting members 101 and elongated base stability members 102, each as described above. The base mounting members are spaced apart by a slight distance and basically extend along the system longitudinal axis substantially in parallel. The base stability members are each attached at a corresponding end of the base mounting members via brackets or clamps 109 and extend transversely therefrom to form an “I” configuration for the base.

The base stability members engage a support surface (as described above for FIG. 2) to stabilize the system frame and include a slight curved configuration to suspend the base mounting members slightly above that surface as described above. The base stability member at the front of the system may include grips 105 disposed at each end and extending rearward therefrom to provide a gripping surface for user feet. The front and/or rear stability members may include feet 112 to engage the support surface and to maintain the system in a substantially level orientation as described above. Alternatively, the base stability members may facilitate mounting of the system to a gripping platform via feet 112 as described above.

Body support 103 is configured to support a user lower body portion (e.g., buttocks, etc.) and is secured to a rear portion of the base mounting members via bracket or clamp 108 as described above. Body support 103 includes substantially upright post 104 and support member 106 attached to the top of the upright post and extending transversely therefrom to form a “T” type configuration as described above. The support member includes a curved configuration to contour a user body portion and generally cylindrical pads 107 extending inward from each support member end to enhance user comfort. The user lower portion (e.g., buttocks, etc.) is basically placed within the support member interior and against pads 107 during game play to support the user in a standing position as described above.

The frame further includes an effector bar 180 for manipulation by a user. In particular, effector bar 180 is attached, via bracket or clamp 111, to base mounting members 101 proximate front base stability member 102. The effector bar is substantially upright and preferably modular and is constructed of a suitably rigid material (e.g., a metal alloy, etc.) that is capable of being slightly deflected within its elastic limit in response to any combination of bending, twisting, tension and compression forces applied by the user to the bar. While the effector bar is generally cylindrical, it is noted that the effector bar may be of any suitable shape (e.g., bent or curved, V-shaped, etc.) and include any suitable exterior surface geometries (e.g., curved, multifaceted, etc.). Additional effector bars may be secured to effector bar 180 to provide various configurations for exercise. Effector bar 180 and body support post 104 may include clamp 131 and tension member 133 or other configurations similar to those described above (e.g., FIGS. 4A-4B) to adjust the height, position and/or orientation of the effector bar or support member relative to a user as described above. Alternatively, extender rods may be employed to configure the effector bar in accordance with user characteristics (e.g., height, reach, etc.).

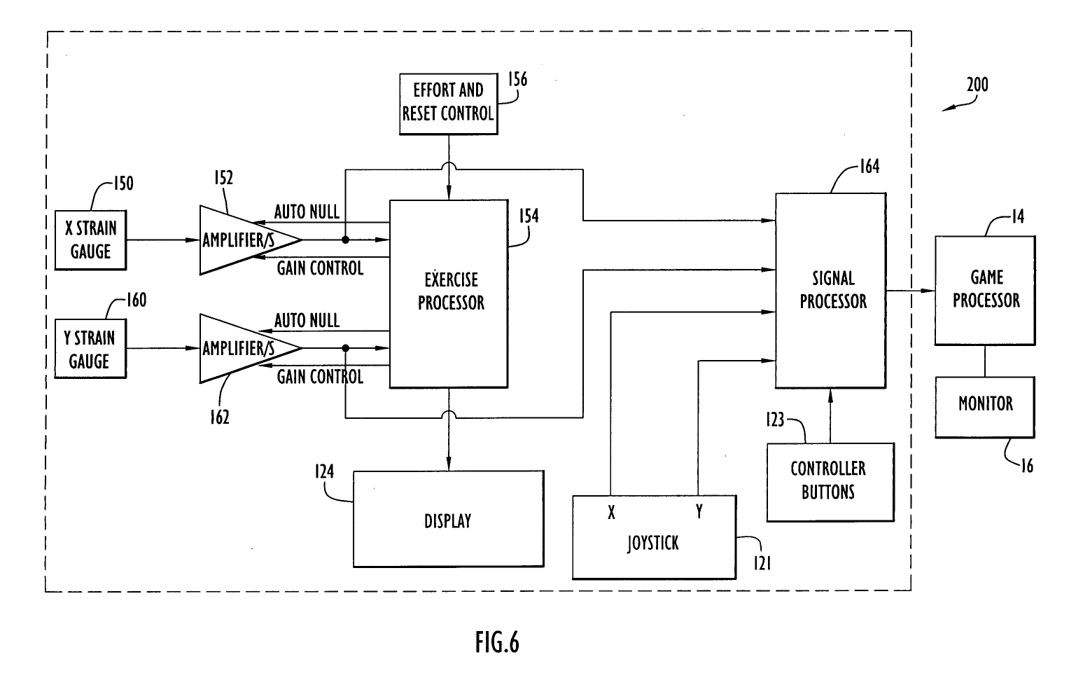

Controller 190 is attached or secured to the effector bar upper portion. The controller is similar to controller 120 described above and may be of the type available for conventional video games (e.g., PS2 available from Sony, XBOX available from Microsoft, GAMECUBE available from Nintendo, etc.), such as the device described in aforementioned U.S. Pat. No. 6,231,444. The controller preferably includes a series of buttons 123 and a joystick 121 disposed on the controller upper portion. Basically, effector bar 180 serves the function of a second controller joystick with respect to a game. The controller generally includes respective signal sources (e.g., variable resistor or potentiometers, etc.) to provide signals indicating button actuation and joystick motion along X (e.g., left/right motions) and Y (e.g., forward/back motions) axes. However, the controller may include any quantity of any type of input devices (e.g., buttons, switches, a keypad, joystick, etc.) and signal sources disposed at any location and arranged in any fashion on the controller. The buttons and joystick may be utilized to enter any desired information (e.g., enter desired user actions for the game, etc.). Further, the controller may include input devices 156 (FIG. 6) to enter and reset resistance controls and reset clock or other functions as described below. Device 156 may be implemented by any conventional or other input devices (e.g., buttons, slides, switches, etc.). The controller lower portion includes a generally “U”-shaped handle or grip 122 for engagement by a user, where the grip lower surface is generally attached to the top surface of effector bar 180. However, the controller may be attached or secured to the effector bar in any desired fashion.

Effector bar 180 includes at least one sensor to measure at least one type of strain applied by the user to that bar. Preferably, effector bar 180 includes strain gauge sensors 150, 160 that are arranged at suitable locations on the bar near the controller. These sensors measure the amount of a strain deformation applied to the bar as a result of the user applying pushing, pulling or lateral forces to the controller handle. By way of example only, sensor 150 may measure force applied to the effector bar along an X-axis (e.g., lateral or left/right forces), while sensor 160 may measure forces applied to the effector bar along a Y-axis (e.g., push/pull or forward/backward forces). Additional effector bars may each include respective strain gauge sensors to measure the amounts of bending strain applied to those bars.

The sensors are connected to or within a control circuit 200 (FIG. 6) disposed within controller 190, where the controller provides appropriate information to game processor 14. Strain gauge measurements that are received by game processor 14 are processed to display a virtual reality scenario on display 16. The scenario is updated in accordance with strain forces applied to the effector bar by a user. The controller may further be configured to control the level of exertion required by a user for one or more effectors in order to achieve a particular response in the virtual reality scenario. Resistance levels may be input to an exercise processor by the user via input device 156 (e.g., a keypad). Alternatively, or in combination with user input, the resistance levels may be controlled by the exercise processor based upon conditions within the virtual reality scenario, such as changing wind conditions, changing grade of the terrain (e:g., going uphill), etc.

A display 124 is further disposed on the controller upper portion and may display various information to the user (e.g., the degree of force applied to a particular effector bar at any given time, the amount of work performed by the user during a particular exercise session, resistance levels, time or elapsed time, force applied to the various axes (X and Y axes), instantaneous force applied and/or any other exercise or other related information). The display is preferably implemented by a Liquid Crystal Display (LCD), but may be any type of display (e.g., LED, etc.).

An exemplary control circuit for the system is illustrated in FIG. 6. Specifically, control circuitry 200 includes sensors 150, 160 and corresponding amplifiers 152, 162, an exercise processor 154 and a signal processor 164. A conventional power supply (not shown) provides appropriate power signals to each of the circuit components. The circuit may be powered by a battery and/or any other suitable power source. A power switch (not shown) may further be included to activate the circuit components.

Sensors 150, 160 are each connected to a respective amplifier 152, 162. The electrical resistance of sensors 150, 160 vary in response to compression and stretching of the effector bar. Amplifiers 152, 162 basically amplify the sensor signals (e.g., in a range compatible with the type of controller employed). The amplified voltage value is sent by each amplifier to exercise processor 154. Exercise processor 154 may be implemented by any conventional or other processor and typically includes circuitry and/or converts the analog signals from the amplifiers to digital values for processing. Basically, the amplified sensor value represents the force applied by the user, where values toward the controller range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the controller range maximum produce digital values toward the maximum values of the quantization ranges.

The exercise processor receives resistance level and reset controls from the user via input device 156 as described above, and controls amplifier gain parameters to adjust system resistance in accordance with the user specified controls. In particular, the exercise processor adjusts the gain control of the amplifiers in order to facilitate a resistance level in accordance with user input and/or the virtual reality scenario. The gain control parameter basically controls the amount of gain applied by the amplifier to an amplifier input (or sensor measurement). Since greater amplified values correspond to a greater force, increasing the amplifier gain enables a user to exert less force to achieve a particular amplified force value, thereby effectively lowering the resistance of the system for the user. Conversely, reducing the amplifier gain requires a user to exert greater force to achieve the particular amplified force value, thereby increasing the resistance of the system for the user. The exercise processor further adjusts an amplifier Auto Null parameter to zero or tare the strain gauge sensors.

The exercise processor is further connected to display 124 to facilitate display of certain exercise or other related information as described above. The exercise processor receives the amplified sensor values and determines various information for display to a user (e.g., the degree of force applied to a particular effector bar at any given time, the amount of work performed by the user during a particular exercise session, resistance levels, time or elapsed time, force applied to the various axes (X and Y axes), instantaneous force applied and/or any other exercise or other related information). In addition, the exercise processor resets various parameters (e.g., resistance, time, work, etc.) in accordance with reset controls received from input device 156.

Signal processor 164 receives the signals from amplifiers 152, 162, and the signal sources for joystick 121 and buttons 123. The signal processor inputs are typically mapped to game functions in accordance with the game software executed by game processor 14. The signal processor may be implemented by any conventional or other processor and typically includes circuitry and/or converts the analog signals from the amplifiers and/or signal sources for the joystick and/or buttons to digital values for processing in substantially the same manner described above. The signal processor samples memory locations receiving the inputs at predetermined time intervals (e.g., preferably on the order of ten milliseconds or less) to continuously process and send information to the game processor to update and/or respond to an executing gaming application.

Basically, the signal processor processes and arranges the input signals into suitable data packets for transmission to the game processor. The signal processor may process raw digital values in any fashion to account for various calibrations or to properly adjust the values within quantization ranges. The data packets are in a format resembling data input from a standard peripheral device (e.g., game controller, etc.). For example, the processor may construct a data packet that includes the status of all controller input devices (e.g., joystick 121, buttons 123, etc.) and the values of each sensor. By way of example only, the data packet may include header information, X-axis information indicating a corresponding sensor force and joystick measurement along this axis, Y-axis information indicating a corresponding sensor force and joystick measurement along this axis, rudder or steering information, throttle or rate information and additional information relating to the status of input devices (e.g., buttons, etc.). Additional packet locations may be associated with data received from controller or other input devices connected with the signal processor, where the input devices represent additional operational criteria for the scenario (e.g., the firing of a weapon in the scenario when the user presses an input button, throttle, etc.). The game processor processes the information or data packets in substantially the same manner as that for information received from a conventional peripheral (e.g., game controller, etc.) to update and/or respond to an executing gaming application (e.g., game, etc.).

Operation of system 170 is described with reference to FIGS. 5-6. Initially, the user couples the system to game processor 14. A game is selected and executed on the game processor, and the user mounts system 170 to engage in an isometric exercise in order to interact with the game. The user operates system 170 with the user lower body portion (e.g., buttocks, etc.) against body support 103, the user feet engaging grips 105 (or the gripping platform) and the user hands placed on controller handle 122. The user grips the controller handle and applies a force to the controller to exert a strain on the effector bar. The user applies one or more forces to the controller and, hence, the effector bar with respect to at least one of the X and Y axes so as to effect corresponding movement, for example, of a character or an object in the scenario displayed by the game processor. The user may further manipulate joystick 121, buttons 123 and/or other controller input devices for additional actions depending upon the particular game. In addition, the user may enter desired parameters (e.g., reset, resistance, etc.) via input devices 156 to control system operation as described above.

The signals from the sensors and input devices 156 are provided to exercise processor 154 to display various information on display 124 and control system operation as described above. The signals from the sensors and control input devices (e.g., joystick, buttons, etc.) are provided to signal processor 164 as described above. The signal processor generates the data packets for transference to game processor 14. The game processor processes the information or data packets in substantially the same manner as that for information received from a conventional peripheral (e.g., game controller, etc.) to update and/or respond to an executing gaming application. Thus, the force applied by the user to the effector bar results in a corresponding coordinate movement or action in the scenario displayed on display 16 in accordance with the function assigned to the bar. In other words, user exercise serves to indicate desired user actions or movements to the game processor to update movement or actions of characters or objects within the game in accordance with the function assigned to the bar. For example, when the effector bar controls accelerator and steering functions, application of a forward force to the controller may serve as the accelerator, while lateral force applied to the controller may serve as the steering function.

It will be appreciated that the embodiments described above and illustrated in the drawings represent only a few of the many ways of implementing a game controller support structure and isometric exercise system and method of facilitating user exercise during game interaction.

The controllers may be of any shape or size, may be constructed of any suitable materials, and may be of the type of any commercially available or other game controller (e.g., those for use with PS2, XBOX, GAMECUBE, etc.). The controllers may include any quantity of any types of input devices (e.g., buttons, slides, joysticks, track type balls, etc.) disposed at any locations and arranged in any fashion. The controllers may include any quantity of any types of signal source devices to generate signals in accordance with input device manipulation (e.g., variable resistors or potentiometers, switches, contacts, relays, sensors, etc.). The signal sources may correspond with any quantity of motion axes for an input device. The controllers may include any quantity of grips or handles of any shape or size disposed at any suitable locations. The controllers may include any quantity of any types of displays (e.g., LED, LCD, etc.) of any shape or size and/or input devices (e.g., buttons, joysticks, etc.) at any desired locations to display and enter any desired information.

The game processor may be implemented by any quantity of any personal or other type of computer or processing system (e.g., IBM-compatible, Apple, Macintosh, laptop, palm pilot, microprocessor, gaming consoles such as the XBOX system from Microsoft Corporation, the PLAY STATION 2 system from Sony Corporation, the GAMECUBE system from Nintendo of America, Inc., etc.). The game processor may be a dedicated processor or a general purpose computer system (e.g., personal computer, etc.) with any commercially available operating system (e.g., Windows, OS/2, Unix, Linux, etc.) and/or commercially available and/or custom software (e.g., communications software, application software, etc.) and any types of input devices (e.g., keyboard, mouse, microphone, etc.). The game processor may execute software from a recorded medium (e.g., hard disk, memory device, CD, DVD or other disks, etc.) or from a network or other connection (e.g., from the Internet or other network).

The support structure, exercise system and associated components (e.g., frame, effector bar, connectors, base, base members, body support, grips, etc.) may be of any size or shape, may be arranged in any fashion and may be constructed of any suitable materials. The mounting and stability members may be of any quantity, shape or size, may be arranged in any fashion and may be constructed of any suitable materials. The mounting and stability members may be secured to each other at any locations via any conventional or other fastening devices (e.g., brackets, clamps, etc.). The stand and body support may be of any quantity, shape or size, may be arranged in any fashion and may be constructed of any suitable materials. The stand and body support may be secured to the mounting members or at any other frame locations via any conventional or other fastening devices (e.g., brackets, clamps, etc.). The structure and exercise system may include any quantity of grips of any shape or size disposed at any suitable locations to accommodate user feet. Alternatively, the structure and exercise system may be mounted to any type of gripping surface via any conventional or other mounting techniques (e.g., bolts, fasteners, lay on surface based on structure or system weight, etc.). The gripping surface may include a single platform of any size or shape or a plurality of gripping segments or planks of any size or shape and arranged in any fashion. The grips and gripping surface may be constructed of any suitable materials (e.g., rubber, plastic, etc.).

The support member and post may be of any quantity, shape or size, may be arranged in any fashion and may be constructed of any suitable materials. The support member may include any quantity of pads of any shape or size disposed at any suitable locations. The support member may be configured to accommodate any desired user body portion. The stand and effector bar may include any conventional or other controllers (e.g., any of the controllers described above, etc.) for any gaming or other application. The stand and effector bar may include any suitable dimensions requiring a user to operate the supported controller in a standing position. The controller may be secured to the stand, effector bar or frame at any location via any conventional or other securing techniques (e.g., clamps, brackets, adhesives, etc.). Alternatively, the controller may be formed integral with the stand, effector bar or frame at any location.

The stand, effector bar and body support may include fixed dimensions or include any desired mechanisms to adjust their height to accommodate a user. The upper and lower rods may be of any quantity, shape or size and may be constructed of any suitable materials. The upper and lower rods may include any conventional or other mating configurations (e.g., telescoping or partial insertion of one rod within the other in any arrangement (e.g., lower rod within the upper rod, upper rod within the lower rod, etc.), sliding relation where the rods are placed adjacent in facing relation, etc.) enabling adjustment of controller or support member height. The openings may be of any quantity, shape or size and may be disposed at any suitable locations. The pin may be of any quantity, shape or size and may be constructed of any suitable materials. The clamp may be implemented by any quantity of conventional or other pressure application devices (e.g., clamp, vice, etc.) and utilize any quantity of any types of conventional or other tension devices (e.g., lever, screw, bolt, etc.) to adjust pressure applied by the clamp. The stand, effector bar and body support may include any quantity of any conventional or other pivoting mechanisms (e.g., hinges, gimbal, ratchet, gears, bracket, etc.) disposed at any suitable locations to enable manipulation of the controller and support member to any desired positions and/or orientations relative to a user.

The structure and exercise system may be utilized with or without the body support, while the stand and/or effector bar may alternatively be mounted or secured to any desired supporting surface (e.g., wall, ceiling, floor, furniture, door, etc.) and/or may further be mounted to or include any other devices or frames that accommodate the user during game play (e.g., keyboard holders, body braces, cup holders, etc.).

The exercise system effector bar may be constructed of any suitable materials that preferably are subject to measurable deflection within an elastic limit of the materials when subjected to one or more straining or other forces by the user. The effector bar may be of any quantity, shape or size, have any suitable geometric configurations, and two or more effector bars may be combined in any suitable manner to yield a system frame that conforms to a desired design for a user for a particular application. Any suitable number of any types of sensors (e.g., strain gauges, etc.) may be applied to an effector bar to facilitate the measurement of any one or more types of strain or other forces applied by the user (e.g., bending forces, twisting forces, compression forces and/or tension forces). The exercise system may include any quantity of effector bars at any location to receive force from any desired user body portions (e.g., hands, arms, legs, thighs, abdomen, neck, etc.).

Any suitable connector may be utilized to connect any two or more effector bars together, including, without limitation, lug nuts, couplings, tee fittings, wye fittings and cross fittings. Any number of connectors may be utilized to form a system frame of effector bars. The connectors may be constructed of any suitable materials. The frame may include any quantity of any type of user support disposed at any locations to support a user or any desired user body portions.

Any suitable number of sensors may be utilized to measure any type of strain or other force applied to any suitable number of effector bars. The sensors may be constructed of any suitable materials, may be disposed at any effector bar locations and may be of any suitable type (e.g., strain gauge, etc.). Further, the sensors may include any electrical, mechanical or chemical properties that vary in a measurable manner in response to applied force to measure force applied to an object. The handle of the exercise system controller may be of any shape or size and disposed at any location to receive force applied by a user. Alternatively, the user may apply force directly to the effector bar. The effector bars may be assigned the gaming functions of any desired controller input devices.

The processors (e.g., exercise, signal, game, etc.) may be implemented by any quantity of any type of microprocessor, processing system or other circuitry, while the control circuitry may be disposed at any suitable locations on the frame, within the controller or, alternatively, remote from the frame. The control circuitry and/or signal processors may be connected to one or more game processors or host computer systems via any suitable peripheral, communications media or other port of those systems. The signal processors may further arrange digital data representing force measurements by sensors and other controller information into any suitable data packet format that is recognizable by the game processor or host computer system receiving data packets from the signal processors. The data packets may be of any desired length, include any desired information and be arranged in any desired format.

The signal processors may sample the information at any desired sampling rate (e.g., seconds, milliseconds, microseconds, etc.), or receive measurement values or other information in response to interrupts. The analog values may each be converted to a digital value having any desired quantity of bits or resolution. The processors (e.g., signal, exercise, etc.) may process analog or raw digital values in any desired fashion to produce any desired information for transference to the display, game processor or host computer system. This information is typically dependent upon a particular application. The correlation between the measured force and provided value for that force may be determined in any desired fashion. By way of example only, the amplified measurement range may be divided into units corresponding to the resolution of the digital value. For an eight bit unsigned digital value (e.g., where the value indicates the magnitude of force), each increment represents 1/256 of the voltage range. With respect to a five volt range, each increment is 5/256 of a volt, which is approximately 0.02 volts. Thus, for an amplified force measurement of three volts, the digital value may correspond to approximately 150 (i.e., 3.0/0.2). The exercise processor may determine any desired information for display to a user (e.g., the degree of force applied to a particular effector bar at any given time, the amount of work performed by the user during a particular exercise session, resistance levels, time or elapsed time, force applied to the various axes (X and Y axes), instantaneous force applied and/or any other exercise or other related information).

Any suitable number of any types of conventional or other circuitry may be utilized to implement the control circuit, amplifiers, sensors and processors (e.g., exercise, signal, etc.). The amplifiers may produce an amplified value in any desired voltage range, while the A/D conversion may produce a digitized value having any desired resolution or quantity of bits (e.g., signed or unsigned). The control circuit may include any quantity of the above or other components arranged in any fashion. The resistance change of the sensors may be determined in any manner via any suitable conventional or other circuitry. The amplifiers and processors (e.g., exercise, signal, etc.) may be separate within a circuit or integrated as a single unit. Any suitable number of any type of conventional or other displays may be connected to the processors (e.g., exercise, signal, game, etc.) to provide any type of information relating to a particular computer interactive isometric exercise session. A display may be located at any suitable location on or remote from the exercise system.

Any suitable number of additional input devices may be provided for the system to enhance virtual reality simulation scenarios. The input devices may be provided on any suitable number of control panels that are accessible by the user during system operation and have any suitable configuration (e.g., buttons, switches, keypads, etc.). Optionally, input devices may be provided (e.g., foot pedals, stairs, ski type exercisers, treadmills, etc.) that provide isokinetic and/or isotonic exercise features in addition to the isometric exercise features provided by effectors. The additional exercise input devices may further be resistance controlled by the exercise processor.

The resistance level may be controlled by adjusting amplifier or other parameters. Alternatively, the resistance level may be controlled based on thresholds entered by a user. For example, the processors (e.g., exercise and/or signal processors) may be configured to require a threshold resistance level be achieved, which is proportionate to the amount of straining force applied by the user to one or more effectors, before assigning appropriate data values to the data packets to be sent to the game processor or host computer. Threshold values for the change in strain gauge resistance may be input to the processor by the user via an appropriate input device (e.g., a keypad).

It is to be understood that the software of processors (e.g., exercise, game, signal, etc.) may be implemented in any desired computer language, and could be developed by one of ordinary skill in the computer and/or programming arts based on the functional description contained herein. Further, any references herein of software performing various functions generally refer to computer systems or processors performing those functions under software control. The processors (e.g., exercise, signal, etc.) may alternatively be implemented by hardware or other processing circuitry, or may be implemented on the game processor or host system as software and/or hardware modules receiving the sensor and/or input device information or signals. The various functions of the processors (e.g., exercise, signal, game, etc.) may be distributed in any manner among any quantity (e.g., one or more) of hardware and/or software modules or units, processors, computer or processing systems or circuitry, where the processors, computer or processing systems or circuitry may be disposed locally or remotely of each other and communicate via any suitable communications medium (e.g., LAN, WAN, Intranet, Internet, hardwire, modern connection, wireless, etc.). The software and/or algorithms described above may be modified in any manner that accomplishes the functions described herein.

The terms “upward”, “downward”, “top”, “bottom”, “side”, “front”, “rear”, “upper”, “lower”, “vertical”, “horizontal”, “height”, “width”, “length”, “forward, “backward”, “left”, “right” and the like are used herein merely to describe points of reference and do not limit the present invention to any specific orientation or configuration.

The present invention structure and exercise system is not limited to the gaming applications described above, but may be utilized for any processing system, software or application.

From the foregoing description, it will be appreciated that the invention makes available a novel game controller support structure and isometric exercise system and method of facilitating user exercise during game interaction, wherein a game controller support structure requires a user to operate a controller in a standing position and/or to exercise to interact with a game.

Having described preferred embodiments of a novel game controller support structure and isometric exercise system and method of facilitating user exercise during game interaction, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A support structure for enabling interaction with a gaming application comprising:
a base including at least one elongated longitudinal member extending along a structure longitudinal axis and plurality of elongated transverse members each secured to and extending transversely from a corresponding longitudinal member end;
a game controller to interact with said gaming application; and
a rod secured to said base and including said game controller secured thereto, wherein said rod includes dimensions sufficient to support said game controller above said base and in a position enabling a user to operate said game controller in a standing position.

2. The support structure of claim 1 further including:
at least one gripping surface coupled to said base to accommodate user feet.

3. The support structure of claim 1, wherein said rod includes an adjustment mechanism to adjust at least one of a position and orientation of said game controller relative to said user.

4. The support structure of claim 3, wherein said adjustment mechanism includes a dimension adjustment mechanism to adjust dimensions of said rod and a position of said game controller relative to said user.

5. The support structure of claim 3, wherein said adjustment mechanism includes at least one pivot mechanism to adjust orientation of said game controller relative to said user.

6. The support structure of claim 1 further including:
a body support secured to said base to support a user lower body portion.

7. The support structure of claim 6, wherein said body support includes:
a post secured to said base; and
a support member secured to said post to engage and support said user lower body portion.

8. The support structure of claim 7, wherein said post includes an adjustment mechanism to adjust at least one of a position and orientation of said support member relative to said user.

9. The support structure of claim 8, wherein said adjustment mechanism includes a dimension adjustment mechanism to adjust dimensions of said post and a position of said support member relative to said user.

10. The support structure of claim 8, wherein said adjustment mechanism includes at least one pivot mechanism to adjust orientation of said support member relative to said user.

11. The support structure of claim 1, wherein said rod provides an isometric exercise for said user and includes at least one sensor coupled at a selected location on said rod to measure at least one force applied by said user to at least one of said rod and said game controller, and wherein said applied force effects a measurable strain on said rod.

12. The support structure of claim 11 further including:
a processor including a data processing module to receive and process data corresponding to applied force information measured by said at least one sensor, wherein said data processing module produces information in a format resembling data output from a gaming application peripheral to facilitate user interaction with said gaming application in response to said force applied by said user.

13. The support structure of claim 11, wherein said game controller includes:
a processor including a data processing module to receive and process data corresponding to applied force information measured by said at least one sensor.

14. The support structure of claim 13, wherein said game controller further includes:
a display controlled by said processor to output information relating to said at least one force applied by said user.

15. The support structure of claim 14, wherein said processor further determines an amount of work applied by said user for a selected period of time and controls said display to output information relating to the amount of work applied by said user.

16. The support structure of claim 13, wherein said processor further selectively adjusts an amount of said at least one force that must be applied by said user to facilitate user interaction with said gaming application.

17. The support structure of claim 16 further including:
an input device to input to said processor the amount of said at least one force that must be applied by said user.

18. The support structure of claim 11, wherein said game controller includes a handle to receive at least one force applied by said user.

19. The support structure of claim 1 further including:
at least one input device that is manipulable by said user to effect at least one of isokinetic and isotonic exercise by said user.

20. A support structure for enabling interaction with a gaming application comprising:
a game controller to interact with a gaming application; and
a rod including said game controller secured thereto, wherein said rod is configured for attachment to at least one of a wall, ceiling, floor and door and includes dimensions sufficient to support said game controller in a position enabling a user to operate said game controller in a standing position.

21. The support structure of claim 20, wherein said rod includes an adjustment mechanism to adjust at least one of a position and orientation of said game controller relative to said user.

22. The support structure of claim 20, wherein said rod provides an isometric exercise for said user and includes at least one sensor coupled at a selected location on said rod to measure at least one force applied by said user to at least one of said rod and said game controller, and wherein said applied force effects a measurable strain on said rod and indicates a desired action within said gaming application.

23. A method of enabling interaction with a gaming application comprising:
(a) supporting a game controller above a support surface and in a position enabling a user to operate said game controller in a standing position via a support structure, wherein said support structure includes a base with at least one elongated longitudinal member extending along a structure longitudinal axis and plurality of elongated transverse members each secured to and extending transversely from a corresponding longitudinal member end and a rod secured to said base with said game controller secured thereto; and
(b) interacting with said gaming application via said game controller.

24. The method of claim 23, wherein step (a) further includes:
(a.1) accommodating user feet via a gripping surface secured to said structure.

25. The method of claim 23, wherein step (a) further includes:
(a.1) enabling adjustment of at least one of a position and orientation of said game controller relative to said user.

26. The method of claim 25, wherein step (a.1) further includes:
(a. 1.1) enabling adjustment of dimensions of said rod and a position of said game controller relative to said user.

27. The method of claim 25, wherein step (a.1) further includes:
(a.1.1) enabling pivoting of said game controller relative to said user to adjust game controller orientation relative to said user.

28. The method of claim 23, wherein step (a) further includes:
(a. 1) supporting a user lower body portion via a body support secured to said base, wherein said body support includes a support member to engage and support said user lower body portion.

29. The method of claim 28, wherein step (a.1) further includes:
(a.1.1) enabling adjustment of at least one of a position and orientation of said support member relative to said user.

30. The method of claim 29, wherein said body support further includes a post secured to said base and coupled to said support member, and wherein step (a. 1.1) further includes:
(a. 1.1.1) enabling adjustment of dimensions of said post and a position of said support member relative to said user.

31. The method of claim 29, wherein step (a. 1.1) further includes:
(a.1.1.1) enabling pivoting of said support member relative to said user to adjust support member orientation relative to said user.

32. The method of claim 23, wherein said rod provides an isometric exercise for said user and includes at least one sensor coupled at a selected location on said rod, and step (b) further includes:
(b.1) measuring at least one force applied by said user to at least one of said rod and said game controller, wherein said applied force effects a measurable strain on said rod.

33. The method of claim 32, wherein step (b) further includes:
(b.2) receiving and processing data corresponding to applied force information measured by said at least one sensor.

34. The method of claim 33, wherein step (b) further includes:
(b.3) producing information in a format resembling data output from a gaming application peripheral to facilitate user interaction with said gaming application in response to said force applied by said user.

35. The method of claim 33, wherein step (b) further includes:
(b.3) displaying information relating to said at least one force applied by said user.

36. The method of claim 33, wherein step (b) further includes:
(b.3) determining an amount of work applied by said user for a selected period of time and displaying information relating to the amount of work applied by said user.

37. The method of claim 32, wherein step (b) further includes:
(b.2) selectively adjusting an amount of said at least one force that must be applied by said user to facilitate user interaction with said gaming application.

38. The method of claim 37, wherein step (b.2) further includes:
(b.2.1) enabling entry of the amount of said at least one force that must be applied by said user.

39. The method of claim 32, wherein said game controller includes a handle to receive at least one force applied by said user.

40. The method of claim 23, wherein said support structure includes at least one input exercise device that is manipulable by said user, and step (b) further includes:
(b.1) effecting at least one of isokinetic and isotonic exercise by said user to interact with said gaming application.

41. A method of enabling interaction with a gaming application comprising:
(a) supporting said game controller in a position enabling a user to operate said game controller in a standing position via a rod, wherein said rod includes said game controller secured thereto and is configured for attachment to at least one of a wall, ceiling, floor and door; and
(b) interacting with said gaming application via said game controller.

42. The method of claim 41, wherein step (a) further includes:
(a. 1) enabling adjustment of at least one of a position and orientation of said game controller relative to said user.

43. The method of claim 41, wherein said rod provides an isometric exercise for said user and includes at least one sensor coupled at a selected location on said rod, and step (b) further includes:
(b. 1) measuring at least one force applied by said user to at least one of said rod and said game controller, wherein said applied force effects a measurable strain on said rod and indicates a desired action within said gaming application.
